(19) United States
(12) Patent Application Publication
(10) Pub. No.: US 2022/0039573 A1
(43) Pub. Date: Feb. 10, 2022

(54) Protective Drinking Guard

(71) Applicant: Tonya Pippin, Eustis, FL (US)

(72) Inventor: Tonya Pippin, Eustis, FL (US)

(21) Appl. No.: 17/133,538

(22) Filed: Dec. 23, 2020

Related U.S. Application Data
(60) Provisional application No. 63/060,691, filed on Aug. 4, 2020.

(51) Int. Cl. A47G 19/22; A23L 27/00; A23L 2/56

(52) U.S. Cl. CPC A47G 19/2216; A23L 27/79; A23V 2002/00; A47G 2400/04; A23L 2/56

(57) ABSTRACT

This present invention relates to a protective barrier for a rim of a beverage container, such as a glass, cup, mug, or the like. More specifically, the protective barrier is removably attachable on the rim of the beverage container, thereby allowing the user to place his or her lips and mouth on the protective barrier, rather than directly on the beverage container. The protective barrier may be disposable or reusable, and may further be comprised of an antimicrobial substance, an adhesive and a plurality of flavor crystals that release a flavor to the beverage as it is consumed across the protective barrier.

### CROSS-REFERENCE TO RELATED APPLICATION

The present application claims priority to, and the benefit of, U.S. Provisional Application No. 63/060,691, which was filed on Aug. 4, 2020 and is incorporated herein by reference in its entirety.

### FIELD OF THE INVENTION

The present invention relates generally to the field of accessories for beverage containers, such as cups, glasses, mugs, or the like. More specifically, the present invention relates to a container accessory device which provides a user with a protective barrier for the rim of his or her glass, mug, cup, etc. The protective barrier is capable of protecting the user from any contaminants present on the surface of the container that contacts the user's mouth when consuming a beverage, as well as to potentially prevent the individual from chipping his or her teeth on the edge of the glass, mug, or cup. More particularly, the device is comprised of a relatively small lip-contacting film that fits over and adheres to the edge portion of the beverage container, thereby ensuring that the device remains secured to the beverage container while in use. The invention also allows users to choose between a reusable or a disposable version of the device to accommodate all needs and preferences when consuming beverages at home, at a restaurant, or other location. To use the protective barrier, the user simply presses and seals the device against the glass at an appropriate location and can then safely consume the beverage without having to worry about being exposed to unsanitary particles, germs, microbes, viruses, etc. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

By way of background, various beverage containers, such as cups, glasses, mugs, bottles, and the like are used to consume beverages or drinks. More specifically, a user utilizes these types of containers by accessing the rim of the glass or cup with his or her mouth to consume a beverage, such as tea, coffee, milk, juice, shakes, smoothies, cocktails, beer, soft drinks or the like. Further, such containers are used in many different settings, such as in restaurants, offices, schools, hospitals, airports, homes, medical facilities, hotels, or the like, as well as on trains, airplanes, buses, or the like.

Unfortunately, public places, such as restaurants, offices, schools, hospitals, airports, hotels and the like, are ridden with all kinds of virus, bacteria, germs, harmful particles and the like, with frequently touched items typically being the most common germ hotspots. Also, items such as beverage containers typically come into direct contact with the user as the user's mouth contacts the rim of the container as a beverage is being consumed, thereby placing the user at risk of contamination from harmful particles that are present on the surface of the container and that may have not been successfully removed during dishwashing or cleaning. More specifically, many different types of germs, viruses, bacteria, etc. can be present on the rim of the container, which can then be inadvertently transmitted to the user drinking a beverage from the container.

In times of pandemic, the spread of germs can occur quickly and lead to dangerous consequences. By way of background, a pandemic is an epidemic of any disease that has spread across a large region, such as multiple continents or worldwide, and that affects a substantial number of individuals. In the past, there have been a number of pandemics, such as smallpox, tuberculosis, the plague, Spanish Flu and others. Current pandemics include the coronavirus disease (i.e., COVID-19). Such pandemics are typically caused by the exponential spread of viruses, bacteria or pathogens causing the infectious disease, wherein the pathogens, viruses or bacteria may be spread through frequently touched items, surfaces or the like including, without limitation, the rim of a beverage container. In fact, the rim of a beverage container is particularly effective in transmitting germs, bacteria, viruses and the like because it not only comes into contact with the user's skin (e.g., lips), but also an ingestion pathway (i.e., the open mouth, saliva, etc.).

Many precautions are taken by people in their day-to-day lives to prevent the transmission of harmful germs, bacteria and the like. Also, instilling good personal hygiene habits in one's daily routine is one of the most effective methods to stay safe during a pandemic. For example, people should wash their hands frequently and sanitize surfaces in public before contacting the same, particularly those items that will come into contact with the user's mouth, such as a cup, glass, plate, utensil or the like. Unfortunately, people oftentimes lack the means to properly clean their cup or glass each time the user uses the same.

Therefore, there exists a long felt need in the art for a guard or other accessory for use with a beverage container, such as a cup, mug, glass, etc., which protects the user from coming into contact with germs, bacteria, viruses or the like that may be present on the rim of the cup, mug or glass. There is also a long felt need in the art for a beverage container solution that prevents the transmission of disease through cross contamination. Additionally, there is a long felt need in the art for an accessory that acts as a barrier between the rim of the glass, mug or cup and the mouth of the user, and that is capable of dispensing a primary or complimentary flavor to the beverage being consumed as it passes over the barrier. Moreover, there is a long felt need in the art for a universal lip guarding device which can be easily fitted onto a cup, glass, or mug, or any other beverage holding device. Finally, there is a long felt need in the art for a protective barrier for a cup, glass or mug that is relatively inexpensive to manufacture, and both safe and easy to use.

The subject matter disclosed and claimed herein, in one embodiment thereof, comprises a temporary guard or barrier device for easy and convenient placement on the rim of a glass, mug, cup or other beverage container. The protective barrier prevents the user's mouth from coming into contact with any germs, bacteria, viruses, etc. that may otherwise be present on the rim of the beverage container, particularly those that are used in a public place such as a restaurant, bar, cafeteria, etc. In this manner, the novel protective guard of the present invention accomplishes all of the forgoing objectives, and provides a relatively safe, easy, convenient and cost-effective solution for preventing the transmission of disease.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a protective cover for a rim of a beverage holding container or vessel. The protective cover has a clip shaped structure that easily fits onto the rim of any beverage holding container or vessel, such as a cup, mug, glass, bottle, or the like. The protective cover further comprises a generally rectangular shaped structure that is folded along a line and is comprised of a temporary adhesive. More specifically, the folding line divides the structure into a longer portion and a shorter portion, and fits on a rim of a beverage container, wherein the shorter portion is clipped onto the interior surface of the beverage holder and the longer portion is positioned on an exterior surface of the beverage holder. The adhesive allows the protective cover to temporarily adhere to the beverage holder during use, but is easily removable following use.

In a further embodiment of the present invention, a beverage holder guard is disclosed. The guard includes a flavored substance on an exterior surface, a temporary adhesive on an interior surface, a longer portion, and a shorter portion, wherein the longer portion and the shorter portion are joined at a connecting edge. The connecting edge fits over a portion of the rim of a glass, wherein the longer portion is disposed over an exterior surface of the glass, and the shorter portion is provided over a corresponding interior surface of the glass. In use, the flavored substance contacts the user's lips and may release a flavor upon becoming wet with the beverage in the container as it is consumed.

In a further embodiment of the present invention, the drinking guard can be utilized with a variety of beverage holding containers such as a glass, mug, bottle, cup or other device. The protective drinking guard may be disposable or reusable, as per the preferences of the users. The guard device functions as a barrier between the beverage container and the user's mouth, thereby effectively preventing the transmission of harmful particles, such as germs, viruses, bacteria and the like, from the beverage container to the user. Following use, users can throw away the disposable version of the barrier, or simply wash and reuse the reusable version of the device.

In a further embodiment of the present invention, a method for attaching a protective guard to a container having a beverage contained therein is described. The method comprises the initial step of tearing a pouch that has the protective cover inside. Next, removing the guard from the protective cover and from the pouch. A folding edge of the protective cover is then positioned over the rim of the container such that a longer portion of the protective cover is disposed over an exterior portion of the beverage container, and a shorter portion of the protective cover is provided over an interior portion of the beverage container.

In yet another embodiment of the present invention, a method of attaching a protective guard to a container having a beverage is described. The method includes the initial step of initially pulling an elongated piece of protective guard from a perforated roll of material. The piece of protective guard is then separated from the roll of material by tearing along a perforated line. Next, the separated piece of protective guard is folded along a folding line, and the folding edge of the protective guard is positioned over the rim of the container such that a longer portion of the protective guard is disposed over, and removably adheres to, an exterior portion of the beverage container and a shorter portion of the protective guard is disposed over, and removably adheres to, an interior portion of the beverage container.

In a yet still further embodiment, a drinking guard and container for holding a consumable product is presented, wherein the container comprises an upper end and a rim extending around a periphery of the upper end, and further wherein the rim has a width. The drinking guard is formed from a portion of material and is comprised of a first portion, a second portion, and a central portion. Each of the first and second portions are separated from one another by a fold line, and an area of the fold line defines the central portion. The central portion has a width that is at least equal to the width of the rim, and the first portion is longer than the second portion. The drinking guard is provided in a continuous roll format with a line of perforation defining individual drinking guard areas.

The disposable and reusable versions of the protective cover can be available in individual packages or torn from a perforated roll which contains a plurality of individual protective covers. The protective covers can be constructed using food grade flexible materials, such as silicone, plastic, rubber, or other materials, such as wax coated cardboard or paperboard, or the like. As previously stated, the protective covers may further comprise a temporary, food grade adhesive for removably attaching the cover to a beverage container, and/or a flavored substance such as, for example, peppermint, spearmint, mocha or any other user desired flavor for flavoring the beverage being consumed from the container as it flows over the protective cover and is consumed by the user. The exact size, measurement, construction, and design specifications of the protective cover may vary to suit user need or manufacturing parameters.

In yet another embodiment of the present invention, a method of using a protective guard to create a barrier between a user's mouth and the surface of a beverage container is disclosed. The method comprises the steps of initially attaching a protective guard over a portion of the rim of a beverage container by a clipping mechanism. The beverage is then consumed by the user, whose lips contact only the protective guard and not any portion of the container. In this manner, the protective guard acts a barrier between the user's mouth and the perimeter or rim of a glass, cup, mug, or the like, thereby protecting the user from the inadvertent transmission of disease, germs, bacteria, and the like.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the protective barrier for a beverage container of the present invention in accordance with the disclosed architecture;

FIG. 2 illustrates a perspective view of one potential embodiment of the protective barrier for a beverage container of the present invention in accordance with the disclosed architecture and about to be installed over a rim portion of a glass;

FIG. 3 illustrates a perspective view of one potential embodiment of the protective barrier for a beverage container of the present invention in accordance with the disclosed architecture and installed over a rim portion of a mug;

FIG. 4 illustrates a perspective view of various packaging options for two potential embodiments of the protective barrier for a beverage container of the present invention in accordance with the disclosed architecture;

FIG. 5 illustrates a perspective view of one packaging option for a potential embodiment of the protective barrier for a beverage container of the present invention in accordance with the disclosed architecture and adjacent to a beverage container;

FIG. 6 illustrates a perspective view of another packaging option for a potential embodiment of the protective barrier for a beverage container of the present invention in accordance with the disclosed architecture and adjacent to a beverage container; and

FIG. 7 illustrates a perspective view of one potential embodiment of the protective barrier for a beverage container of the present invention in accordance with the disclosed architecture, wherein the protective barrier is removably attached to a glass that is being used by a user to consume a beverage.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a guard or other accessory for use with a beverage container, such as a cup, mug, glass, etc., which protects the user from coming into contact with germs, bacteria, viruses or the like that may be present on the rim of the beverage container. Additionally, there is a long felt need in the art for an accessory that acts as a barrier between the rim of the glass, mug or cup and the mouth of the user, and that is capable of dispensing a primary or complimentary flavor to the beverage being consumed as it passes over the barrier. Moreover, there is a long felt need in the art for a universal lip guarding device which can be easily and removably fitted onto a cup, glass, or mug, or any other beverage holding device. Finally, there is a long felt need in the art for a protective barrier for a cup, glass or mug that is relatively inexpensive to manufacture, and both safe and easy to use.

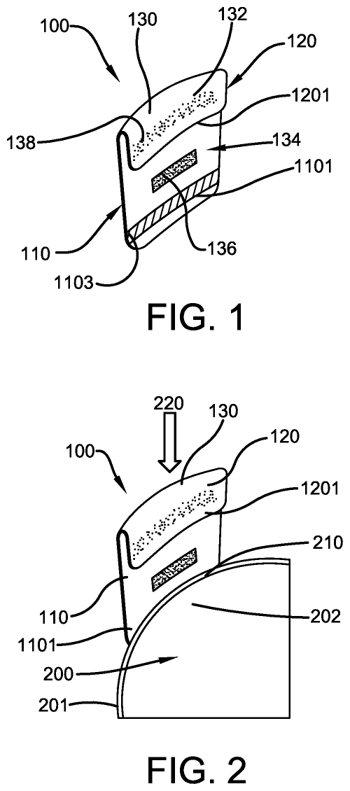

Referring initially to the drawings, FIG. 1 illustrates a perspective view of one potential embodiment of the protective barrier 100 for a beverage container of the present invention in accordance with the disclosed architecture. More specifically, the protective barrier 100 is preferably a generally rectangular piece of material which is folded at a folding edge or perforation line 130. The folding edge 130 divides the rectangular piece of material into a longer portion 110 and a shorter portion 120. As a point of reference, the longer portion 110 refers to the portion of the protective barrier 100 that is positioned adjacent to an exterior portion of a beverage container, such as a glass, cup, mug or the like. By comparison, the shorter portion 120 refers to the portion of the protective barrier 100 that is positioned adjacent to an interior portion of a beverage container, such as a glass, cup, mug or the like.

As explained more fully below, the protective barrier 100 of the present invention is designed to be mounted on a rim portion of a beverage container, such as a glass, cup, mug, or the like. In operation, the protective barrier 100 creates a barrier between the rim of the glass or drinking container and the user's mouth, as the barrier 100 covers a portion of glass on its exterior surface and a portion of rim, such that the user does not come in direct contact with any portion of the surface of the container while sipping or drinking the beverage held therein. The protective barrier 100 protects the user from any contaminants that may be present on the beverage container. The protective barrier 100 may be a reusable or a disposable device to accommodate the requirements of the users when consuming beverages at home, at a restaurant, and more. The disposable version of the protective barrier 100 may be a single use and throw away device, and can be discarded once the barrier 100 has been used. The reusable version of the protective barrier 100 may be used time and again, after it has been washed and/or otherwise sanitized.

The width of the protective barrier 100 (as measured along the rim of the beverage container is preferably from about 30 mm (1.2 inches) to about 80 mm (3.14 inches), with about 40 (1.6 inches) to 70 mm (2.8 inches) being preferred. By comparison, the length of the protective barrier 100 ranges from about 70 mm (2.8 inches) to 120 mm (4.7 inches). The length of the protective barrier 100 is preferably longer than the width so that the protective barrier 100 can extend from the outside surface of the beverage container to a sufficient distance inside the beverage container to provide a protective barrier, such that the user's lips or mouth region do not come into contact with any portion of the beverage container.

In one embodiment, the protective barrier 100 may be comprised of a food grade plastic material, such as polyethylene. In other embodiments, the protective barrier 100 may be comprised of any other suitable material, such as silicone, rubber, cardboard, paperboard, or the like. If paperboard or cardboard is used, the same may be coated with a wax or a plastic material to make the material waterproof. In fact, the protective barrier 100 is preferably water resistant or waterproof so that it does not dissolve or break down during use. The material used should also be flexible to accommodate beverage containers of different sizes and shapes, and may be transparent, translucent or opaque. The protective guard 100 may further comprise different indicia 203, such as designs, patterns, a company logo, personalized name, customized design, or the like as per the requirements of the user. The indicia 203 may also include instructions relating to the use of the protective barrier 100.

As best shown in FIG. 1, the protective barrier 100 further comprises an exterior surface 132 and an inner surface 134. By point of reference, the exterior surface 132 faces outwardly from the beverage container when installed thereon, and the inner surface 134 is immediately adjacent the surface of the container. Accordingly, the inner surface 134 may further comprise a food grade adhesive 136 for ensuring a relatively secure connection between the protective barrier 100 and the beverage container. However, the adhesive 136 should also be temporary in nature, thereby allowing the protective barrier 100 to be easily removed from the container after use, for example, to be discarded of cleaned. The exterior surface 132 may further comprise flavored substance 138 (e.g., flavor crystals sprinkled thereon) such as, for example, peppermint, spearmint, mocha or any other user desired flavor for flavoring the beverage being consumed from the beverage container as it flows over the protective cover 100 and is consumed by the user. The flavored substance/crystals 138 are activated when contacted by a beverage. Additionally, the protective cover 100 may also have an antimicrobial coating, or the antimicrobial coating may be integrated directly into the substrate making up the protective cover 100 as an added precaution against the possible transmission of germs, bacteria, disease and the like from the beverage container to the user.

FIG. 2 illustrates a perspective view of one potential embodiment of the protective barrier 100 for a beverage container of the present invention in accordance with the disclosed architecture and about to be installed over a rim portion 210 of a glass 200. Although the beverage container is illustrated as a glass in the form of a tumbler, it is to be understood that the term as used herein encompasses any beverage container made from any material including, but not limited to, drinking glasses, mugs, wine glasses, coffee cups, and the like. Also, the beverage stored in the glass 200 can be any drink, hot or cold, such as water, tea, coffee, milk, shakes, juice, wine, or the like, which is sipped by the user by placing their mouth over the rim of the glass 200.

FIG. 2 also illustrates a method of slipping the protective cover 100 over the rim portion 210 of the glass 200. More specifically, the user (not shown) attaches the protective cover 100 to the glass 200 by slipping it over the rim portion 210 of the glass 200, such that the longer portion 110 remains on an exterior 201 of the glass 200, and the shorter portion 120 is positioned on the interior 202 of the glass or container 200. A bottom edge 1101 of the longer portion 110 is placed on the exterior 201 of the glass 200, and then the complete protective cover 100 is pushed in a downwards direction 220 towards the bottom of the glass 200, such that the folding edge 130 sits over a portion of the rim 210 of the glass 200. Once the folding edge 130 sits over a portion of the rim 210 of the glass 200, the bottom edge 1201 of the shorter portion 120 is folded inwardly towards the inner surface 202 of the glass 200. As previously mentioned, the interior surface 134 of the protective cover 100 may comprise an adhesive 136 for adhering the protective cover to the glass 200. Alternatively, the interior surface 134 of only the longer portion 110 may include a tacking adhesive strip 1103 so that the protective cover 100 is held in position on the exterior 210 of the glass 200, and does not move.

In operation, the protective cover or guard 100 sits securely on the rim 210 of the glass 200, thereby allowing the user to place his or her lips and mouth on the protective guard 100 rather than directly on the rim or edge of the glass 200. The drinking guard 100 covers both a portion of the exterior surface 201 and interior surface 202 of the glass 200, and functions as a barrier between the glass 200 and mouth, thereby effectively preventing the transmission of harmful particles, such as germs and viruses from the surface of the glass 200 to the user.

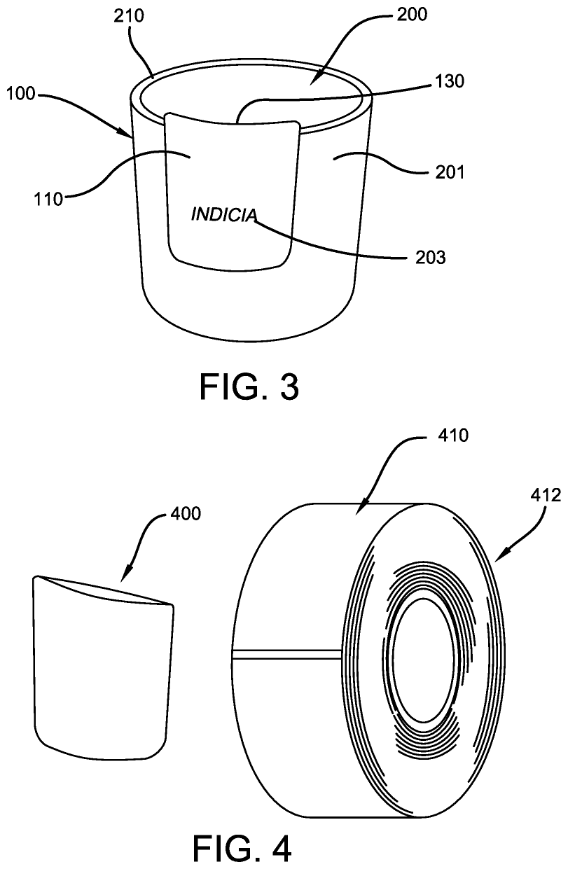

FIG. 3 illustrates a perspective view of one potential embodiment of the protective barrier 100 for a beverage container of the present invention in accordance with the disclosed architecture and installed over a rim portion 210 of a mug 200. More specifically, the protective cover 100 is removably attached to the mug 200, such that the longer portion 110 covers a portion of the exterior surface 201 of the mug 200, wherein the longer portion 110 of the protective cover may optionally have an adhesive 136 to properly affix the cover 100 to the mug 200. In this embodiment, a user may simply press and seal the cover 100 against the mug 200. Alternatively, the protective cover 100 may be comprised of a plastic film, such as a thin vinyl film, that clings to the surface of the container 200 without having to provide a separate adhesive.

As clearly illustrated in FIG. 3, the folding edge 130 sits over and effectively covers a portion of the rim 210 of the glass 200. The covered rim portion acts as a barrier between the mug 200 and the user's mouth and can be easily utilized by the user to sip any beverage or consume other contents inside the glass or container 200. The covered rim portion also allows the user to place his or her lips and mouth on the protective guard 100, rather than directly on the rim 210 of the mug 200.

FIG. 4 illustrates a perspective view of various packaging options for two potential embodiments of the protective barrier 100 for a beverage container of the present invention in accordance with the disclosed architecture. More specifically, the protective cover 100 can be packaged as single use covers, or as a reusable guard in different pouches 400, or may be packaged as a continuous material in a perforated roll dispenser 410. Preferably, a disposable or a reusable version of cover 100 may be easily packaged as an individual piece of material containing the cover 100 inside of a protective pouch 400 until needed, or as part of a roll 412 used with a roll dispenser 410.

Notwithstanding, the packaging of the protective guard 100 is not so limited, and can be packaged in other variations and designs as per the preferences of a user. The user may easily tear the pouch 400 to access the guard 100 stored inside the pouch 400, and can use the cover 100 on a glass or container while sipping any beverage from the glass as required. The pouch 400 is a receptacle for storing the glass guard 100, and may contain one or more covers 100 as per the desires and requirements of the user. In an alternate embodiment, the user may tear off an individual cover 100 from a roll 412 having a series of covers separable by perforated lines. In use, the user may tear a single cover 100 from the perforated line, and use the cover on a glass while sipping any beverage from the glass as required. In this manner, the adhesive 136 on the interior surface 134 of the cover is also protected from drying out until needed.

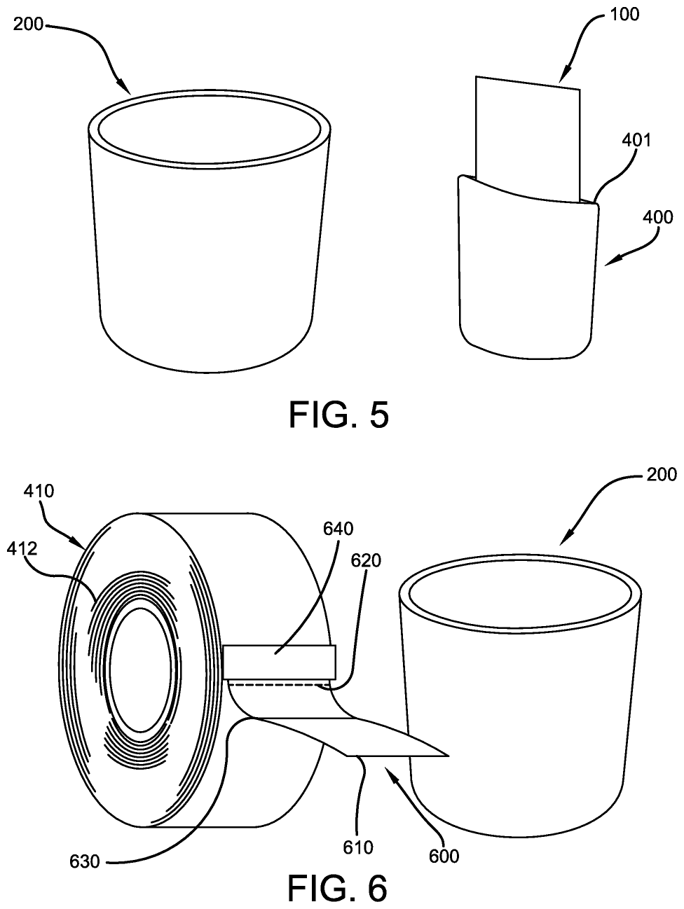

FIG. 5 illustrates a perspective view of one packaging option for a potential embodiment of the protective barrier 100 for a beverage container of the present invention in accordance with the disclosed architecture and adjacent to a beverage container 200. More specifically, a user tears off an edge 401 of the pouch 400 to access the barrier 100 stored inside of the pouch 400. Next, the user pulls out the barrier 100 from the pouch 400 and places it on the beverage container 200. Once the beverage has been consumed, the barrier 100 can be removed from the container and disposed of or properly sanitized and reused. The pouch used to house the barrier 100 of the present invention may include, but is not limited to, flow wrap pouches, individual sachets, chained sachets comprising a tear line between each sachet, and other forms known in the art as suitable for storing nonwoven articles.

FIG. 6 illustrates a perspective view of another packaging option for a potential embodiment of the protective barrier 600 for a beverage container of the present invention in accordance with the disclosed architecture and adjacent to a beverage container 200. More specifically, a user holds an edge 610 of a perforated roll 412 and pulls out a detachable protective barrier 600 off the perforated roll 412 through a dispensing area 640 of a roll dispenser 410. The detachable barrier 600 is torn along a perforated line 620. The roll 412 uses a continuous sheet roll in which perforations at predetermined intervals are provided in advance on a continuous sheet of a material, such as plastic or the like.

Perforation lines 620 in the roll 412 as described can be produced using any art recognized in perforation systems. For example, perforation systems typically include one or more blades comprising a number of teeth. The teeth form the surface of the cutting blade that is used to cut the material of the roll 412, and form the cut portion of the perforation 620. The open areas between the teeth on the blade move over the protective barrier 600 surface, without causing damage to the surface, and thereby creates the bond portion of the perforation 620.

The tear strength can vary depending on the material used, and can range from 3 teeth per inch providing up to ten percent of the hold between successive sheets, and up to 17 teeth per inch which provides about 54% of hold strength between the sheets. The number of cuts, which are made by the teeth of a cutting wheel or perforation bar, to the number of ties, the material that is left between the cuts, varies depending on the particular need of the application. In the present situation, a preferred number of cuts is around 7 per inch up to 12 per inch giving a hold strength ranging from between about 20 percent to about 40 percent.

After an individual protective barrier 600 is torn from the roll 412, the barrier 600 is folded along a fold line 630 to create a clipping structure of barrier 600 that is, in turn, placed over a rim or edge portion of a glass, cup, mug, or other utensils. The fold line 630 creates a central portion of the barrier 600 that is sized and configured to fit on the rim of a drinking vessel.

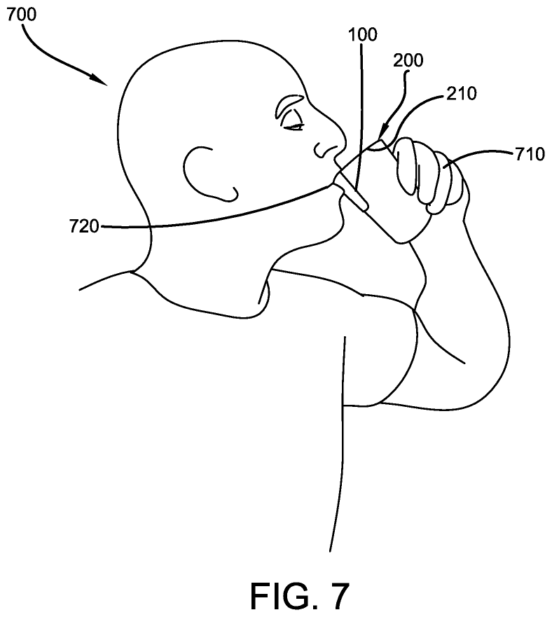

FIG. 7 illustrates a perspective view of one potential embodiment of the protective barrier 100 for a beverage container of the present invention in accordance with the disclosed architecture, wherein the protective barrier 100 is removably attached to a glass 200 that is being used by a user 700 to consume a beverage. More specifically, the user 700 has placed the barrier 100 over a portion of a rim 210 of a glass or container 200, and is holding the glass 200 to sip a beverage out of the glass 200. More specifically, the user 700 places his or her mouth 720 over the covered portion of the rim 210, and sips the beverage inside the glass. The cover 100 placed on the glass 200 prevents direct contact between the glass 200 and the user's mouth 720, and therefore protects the user 700 from any cross contamination and infectious diseases.

The protective barrier/guard 100 may be made available in different sizes and colors to accommodate user need and/or preference, and the exact size, measurement, construction and design specifications of the guard 100 of the present invention may vary upon manufacturing or the particular material that is used. As previously stated, the guard 100 may further comprise logos, indicia 203, trademarks, geometric patterns, customizable colors and fonts, prints and/or images on its surface. Further, the guard 100 may be coated with anti-bacterial or anti-allergic material to provide enhanced protection against various germs, bacteria, virus, or the like.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “glass guard”, “protective barrier”, “protective glass guard”, “device” and “glass barrier” are interchangeable, and refer to the glass guard 100 of the present invention. Also, the glass guard 100 is not limited to use on glasses, and can be used with other beverage holding devices such as cups, mugs, tumblers, bowls or the like.

Notwithstanding the forgoing, the glass guard 100 of the present invention can be of any suitable size and configuration as is known in the art without affecting the overall concept of the invention, provided that it accomplishes the above stated objectives. One of ordinary skill in the art will appreciate that the size, configuration and material of the glass guard 100 as shown in the FIGS. are for illustrative purposes only, and that many other sizes and shapes of the glass guard 100 are well within the scope of the present disclosure. Although the dimensions of the glass guard 100 are important design parameters for user convenience, the glass guard 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A protective drinking accessory comprising:
a piece of material having a fold line, wherein the fold line divides the piece of material into a first portion, a second portion, and a center portion and further wherein the piece of material is water resistant;
the piece of material further comprising an inner surface and an exterior surface and having a width ranging from about 1.2 inches to about 3.14 inches, and a length ranging from about 2.8 inches to about 4.7 inches; and
wherein the first portion is longer than the second portion, and the center portion is sized and configured to fit on a rim of a drinking container.

2. The protective drinking accessory as recited in claim 1, wherein the piece of material is comprised of one of a food grade plastic, a vinyl, a rubber, a silicone, a paperboard or a cardboard.

3. The protective drinking accessory as recited in claim 1, wherein the piece of material is further comprised of at least one of an adhesive, a flavored substance and an antimicrobial substance.

4. The protective drinking accessory as recited in claim 1, wherein at least one edge of one of the first and second portions is comprised of an adhesive for removably attaching the piece of material to the drinking container.

5. The protective drinking accessory as recited in claim 1, wherein the piece of material is comprised of a vinyl and clings to the drinking container.

6. The protective drinking accessory as recited in claim 1, wherein the piece of material is comprised of an indicia.

7. The protective drinking accessory as recited in claim 6, wherein the indicia comprises a set of instructions for using the protective drinking accessory.

8. The protective drinking accessory as recited in claim 1, wherein the piece of material forms a reusable protective barrier between the drinking container and a user's mouth.

9. The protective drinking accessory as recited in claim 3, wherein the flavored substance is comprised of flavored crystals positioned on the exterior surface of the piece of material, and further wherein the flavored crystals are activated when contacted by a beverage.

10. The protective drinking accessory as recited in claim 1 comprised of a continuous roll of materials comprised of a plurality of pieces of material each separable by a perforated line.

11. A drinking guard and container combination comprising:
a container for holding a consumable product, wherein the container is comprised of an upper end and a rim extending around a periphery of the upper end, and further wherein the rim has a width;
a drinking guard having an inner surface, an exterior surface, a first portion, a second portion and a central portion, wherein the first and second portions are separated from one another by a fold line and an area of the fold line defines the central portion;
the central portion having a central portion width that is at least equal to the width of the rim, and wherein the first portion is longer than the second portion; and
an adhesive positioned on the inner surface of the drinking guard for adhering the drinking guard to the container.

12. The drinking guard and container combination as recited in claim 11 further comprising a continuous roll of drinking guards each separable by a line of perforation, wherein the line of perforation has between 3 teeth per inch and 17 teeth per inch.

13. The drinking guard and container combination as recited in claim 12, wherein the line of perforation has a hold strength ranging from between about 10% to 54%.

14. The drinking guard and container combination as recited in claim 11 further comprising a flavored substance positioned on the exterior surface of the drinking guard.

15. The drinking guard and container combination as recited in claim 11, wherein the drinking guard is comprised of one of a food grade plastic, a vinyl, a rubber, a silicone, a paperboard or a cardboard.

16. The drinking guard and container combination as recited in claim 11 further comprising an antimicrobial substance.

17. The drinking guard and container combination as recited in claim 11, wherein the container is one of a cup, a glass, a bottle, a bowl, a mug, or a cup.

18. The drinking guard and container combination as recited in claim 11, wherein the drinking guard is comprised of a vinyl and clings to a surface of the container.

19. A protective barrier for a beverage container, wherein the protective barrier is comprised of:
an exterior surface;
an inner surface;
a select one of a food grade plastic, a vinyl, a rubber, a silicone, a waxed over paperboard or a waxed over cardboard;
a first portion having a first length;
a second portion having a second length, wherein the first length is longer than the second length;
a fold line separating the first portion from the second portion;
an adhesive positioned on the inner surface; and
a plurality of flavor crystals positioned on the exterior surface, wherein the plurality of flavor crystals release a flavoring into a beverage when contacted by the beverage.

20. The protective barrier for a beverage container as recited in claim 19 further comprising an antimicrobial substance.
